(19) United States
(12) Patent Application Publication
(10) Pub. No.: US 2022/0262585 A1
(43) Pub. Date: Aug. 18, 2022

(54) THERMAL CUT-OFF DEVICE HAVING A SINGLE-SIDED SILVER-PLATED HOUSING

(71) Applicant: Therm-O-Disc Incorporated, Mansfield, OH (US)

(72) Inventors: Changcai ZHAO, Zhuhai (CN); Rong GUAN, Zhuhai (CN); Hongfang XIE, Zhuhai (CN)

(73) Assignee: Therm-O-Disc Incorporated, Mansfield, OH (US)

(21) Appl. No.: 17/671,755

(22) Filed: Feb. 15, 2022

(30) Foreign Application Priority Data
Feb. 18, 2021 (CN) 2021101879891

(51) Int. Cl. H01H 37/32; H01H 85/175

(52) U.S. Cl. CPC H01H 37/32; H01H 2037/528; H01H 85/175

(57) ABSTRACT

A metal housing or casing for a thermal fuse (i.e., a thermal cut-off device) that has a multilayer metal construction including a copper-based layer, a first nickel layer disposed on a first side of the copper-based layer and including an outer surface of the casing, a second nickel layer disposed on a second side of the copper-based layer opposite to the first side of the copper-based layer, and a single silver layer disposed only on the second nickel layer and comprising the inner surface of the casing.

### CROSS-REFERENCE TO RELATED APPLICATIONS

This Application claims priority from Application 2021101879891 filed on Feb. 18, 2021 in China. The entire disclosure of the above application is incorporated herein by reference.

### FIELD

The present disclosure relates to a temperature control device, and in particular to a thermal fuse (e.g., a thermal cut-off device (TCO)) and a single-sided, silver-plated metal housing.

### BACKGROUND

This section provides background information related to the present disclosure which is not necessarily prior art.

In order to protect industrial or household electronic and electrical equipment from overheating and damage, thermal fuses are used.

A thermal fuse is a protection component that senses the temperature of the device and quickly cuts off the circuit when abnormally overheating. It has a wide range of application scenarios, including various home appliances, mobile equipment, communication equipment, office equipment, vehicle equipment, power adapters, and chargers, motors, batteries and other electronic components.

Because the conductivity of silver is relatively high, silver can be used as the plating layer of the copper shell of the thermal fuse, and the inner surface and the outer surface of the shell of the thermal fuse are plated with silver.

However, typical silver-plated thermal fuse components use a large amount of silver and the amount of silver used is unreasonable, wasteful and unduly increases costs.

Regarding the problem of the unreasonable silver content in the thermal fuse in the related technology, no effective solution has been proposed yet.

### SUMMARY

This section provides a general summary of the disclosure, and is not a comprehensive disclosure of its full scope or all of its features.

In order to solve the above problems, a thermal fuse and a metal shell used for the thermal fuse are provided.

In one aspect, a thermal fuse is provided, including a housing extending from a first end to a second end along a longitudinal axis. The housing defines an inner space, and the housing has an electrically conductive inner surface and an outer surface.

A first conductive member is disposed at the first end of the housing and extends from the housing in a first direction along the longitudinal axis. The first conductive member is electrically connected to the inner surface of the housing.

A second conductive member is provided at the second end of the housing and extends from the housing in a second direction along the longitudinal axis. The second conductive member includes a contact surface at a distal endin the internal space of the housing.

A thermally responsive member is disposed in the inner space of the housing and located between the distal end of the second conductive member and the first conductive member. The thermally responsive member is formed from a non-conductive material, and the non-conductive material changes from a solid physical state to a non-solid physical state when reaching a temperature at or greater than a threshold temperature.

A conductive movable contact member is provided inside the inner space of the housing and located between the thermally responsive member and the distal end of the second conductive member. A perimeter part of the movable contact member is in direct contact with the inner surface of the housing.

A first biasing member is disposed between the thermally responsive member and the movable contact member. The first biasing member acts on the movable contact in a first direction along the longitudinal axis.

A second biasing member is disposed between the movable contact member and the second end of the housing and is positioned opposite to the first biasing member. The second biasing member acts on the movable contact member in a second direction along the longitudinal axis opposite to the first direction.

When the thermally responsive member is lower than the threshold temperature, the biasing force of the first biasing member is greater than the biasing force of the second biasing member, and the movable contact member is in direct contact with and electrically connected to the distal end of the second conductive member. When the second conductive member is in direct contact with the moveable contact member, the thermal fuse is operable to flow current through the thermal fuse, wherein the current path through the thermal fuse is from the first conductive member to the housing to the inner surface of the housing, then to the movable contact member, and then to the second conductive member.

Wherein, when the temperature of the thermally responsive member is at or higher than the threshold temperature, the biasing force of the first biasing member is less than the biasing force of the second biasing member, and the movable contact member moves away from the and out of contact with the distal end of the second conductive member. When the distal end of the second conductive member is separated from the movable contact member, the peripheral portion of the movable contact member remains in contact with the inner surface of the housing but the movable contact member is no longer electrically connected to the second conductive member. As such, the current path through the thermal fuse is interrupted and the thermal fuse is no longer operable to flow current through the thermal fuse.

The housing includes a multilayer metal material. The multilayer metal material includes: a copper-based layer; a first nickel layer disposed on a first side of the copper-based layer and including the outer surface; a second nickel layer arranged on the second side of the copper base layer, and the second side and the first side are arranged opposite to each other; and the silver layer is arranged on the second nickel layer and includes the inner surface.

Preferably, the thickness of the first nickel layer ranges from 15 microinches to about 25 microinches, the thickness of the second nickel layer ranges from 3 microinches to 5 microinches, and the thickness of the silver layer ranges from 4 microinches to 100 microinches.

Preferably, the thickness of the silver layer is less than 70 microinches.

Preferably, the thickness of the silver layer is less than 30 microinches.

Preferably, the thickness of the silver layer is less than 10 microinches.

Preferably, the thickness of the silver layer ranges from 4 microinches to about 6 microinches.

Preferably, the roughness Ra of the outer surface of the shell is greater than 35 microinches.

Preferably, the copper-based layer includes: copper, the content range is 84% to 86%, lead, the content range is less than or equal to 0.03%, iron, the content range is less than or equal to 0.05%, and cadmium, the content range is less than or equal to 0.007%, Nickel, the content range is less than or equal to 0.01%, and the rest is zinc.

Preferably, the copper base layer includes brass H85Cu.

Preferably, when the thermally responsive member is higher than the threshold temperature and the movable contact member moves, the peripheral portion of the movable contact member remains in contact with the inner surface of the housing, and The frictional force against the movement between the peripheral portion of the movable contact member and the inner surface of the housing is less than about 0.3 kilogram force (kgf).

According to another aspect of the present invention, there is also provided a metal housing for a thermal fuse.

The thermal fuse includes a first conductive member disposed at a first end of the housing and extending from the housing in a first direction along a longitudinal axis of the housing. A second conductive member is provided at the second end of the housing, extends from the housing in a second direction along the longitudinal axis, and includes a contact surface at a distal end of the second conductive member disposed in the internal space of the housing. A thermally responsive member is included in the thermal fuse and is formed from a non-conductive material. The non-conductive material changes from a solid physical state to a non-solid physical state when reaching a threshold temperature or higher than the threshold temperature. The thermally responsive member is disposed in an internal space of the housing, and is located between the first conductive member and the distal end of the second conductive member.

A conductive movable contact member is provided inside the housing and located between the thermally responsive member and the distal end of the second conductive member. A perimeter part of the movable contact member is in contact with the inner surface of the housing.

A first biasing member is disposed between the thermally responsive member and a first side of the movable contact member and acts on the movable contact in a first direction along the longitudinal axis.

A second biasing member is disposed between the second end of the housing and a second side of the movable contact member andis positioned opposite to the first biasing member. Thre second biasing member acts on the movable contact in a second direction along the longitudinal axis.

Wherein, when temperature of the thermally responsive member is lower than the threshold temperature, the biasing force of the first biasing member is greater than the biasing force of the second biasing member, and the movable contact member is in direct contact with and electrically connected to the second conductive member. When the distal end of the second conductive member is in direct contact with the moveable contact member, the thermal fuse is operable to flow current through the thermal fuse, wherein the current path through the thermal fuse is from the first conductive member to the inner surface of the housing, then to the movable contact member, and then to the second conductive member.

Wherein, when temperature of the thermally responsive member is at or higher than the threshold temperature, the biasing force of the first biasing member is less than the biasing force of the second biasing member, and the movable contact member moves away from and out of contact with the distal end of the second conductive member. When the distal end of the second conductive member is separated from the the movable contact member, the peripheral portion of the movable contact member remains in contact with the inner surface of the housing but the movable contact member is no longer electrically connected to the second conductive member. As such, the current path through the thermal fuse is interrupted and the thermal fuse is no longer operable to flow current through the thermal fuse.

Wherein, the housing includes a multilayer metal material The multilayer metal material includes: a copper-based layer; a first nickel layer disposed on a first side of the copper-based layer and including the outer surface; a second nickel layer arranged on the second side of the copper base layer, and the second side and the first side are arranged opposite to each other; and the silver layer is arranged on the second nickel layer and includes the inner surface.

Preferably, the thickness of the first nickel layer ranges from 15 microinches to about 25 microinches, the thickness of the second nickel layer ranges from 3 microinches to 5 microinches, and the thickness of the silver layer ranges from 4 microinches to 100 microinches.

Preferably, the thickness of the silver layer is less than 70 microinches.

Preferably, the thickness of the silver layer is less than 30 microinches.

Preferably, the thickness of the silver layer is less than 10 microinches.

Preferably, the thickness of the silver layer ranges from 4 microinches to about 6 microinches.

Preferably, the roughness Ra of the outer surface of the shell is greater than 35 microinches.

Preferably, the copper-based layer includes: copper, the content range is 84% to 86%, lead, the content range is less than or equal to 0.03%, iron, the content range is less than or equal to 0.05%, and cadmium, the content range is less than or equal to 0.007%, Nickel, the content range is less than or equal to 0.01%, and the rest is zinc.

Through the technical solution provided by the present invention, the housing of the thermal fuse includes multiple layers of metal materials, including a copper base layer, a first nickel layer, a second nickel layer, and a silver layer. The silver layer is arranged on the second nickel layer and includes an inner surface. Only the inside of the housing, therefore, is silver-plated, and the outer surface is a nickel layer, so that the use of silver as an electrically conductive medium is minimized but still provides that the thermal fuse can complete the interruption performance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front cross-sectional view of a thermal cut-off device as is well-known in the art; and

FIG. 2 is a schematic diagram of a multilayered metal material structure of a housing for a thermal cut-off device according to an embodiment of the present disclosure.

### DETAILED DESCRIPTION

Example embodiments will now be described more fully with reference to the accompanying drawings.

It should be noted that the embodiments in this application and the features in the embodiments can be combined with each other if there is no conflict.

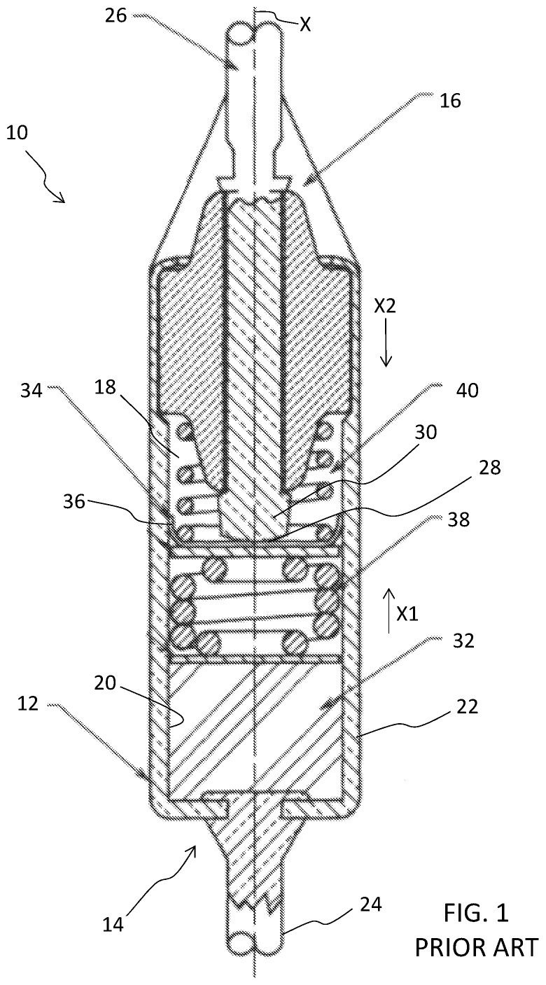

A thermal fuse (or thermal cut-off device) construction is well-known and is shown in FIG. 1. The thermal fuse 10 includes a housing 12 (e.g., a metal casing) extending from a first end 14 to a second end 16 along a longitudinal axis X, the housing 12 having an inner space 18, and the housing 12 having an inner surface 20 and an outer surface 22.

A first conductive member 24 (e.g., a pin) is provided at the first end 14 of the housing 12 and extends from the housing 12 in the direction along the longitudinal axis X.

A second conductive member 26 is arranged at the second end 16 of the housing 12, extends from the housing 12 in a direction along the longitudinal axis X, and includes a contact surface 28 at a distal end 30, which is arranged in the inner space 18 of the housing.

A thermally responsive member 32 (e.g., a thermal pellet) is provided in the inner space 18 of the housing 12 and is formed from a non-conductive material. The non-conductive material changes from a solid physical state to a non-solid physical state when the temperature of the thermally responsive member 32 reaches (or exceeds) a threshold temperature. .

A conductive movable contact member 34 (e.g., a star contact) is disposed inside the housing 12 and located between the thermally responsive member 32 and the distal end 30 of the second conductive member 26. The movable contact member 34 includes a peripheral portion 36 in contact with the inner surface 20 of the housing 12.

A first biasing member 38 (e.g., a first compression spring) is disposed between the thermally responsive member 32 and the movable contact member 34. The first biasing member 38 acts on the movable contact member 34 in a first direction (arrow X1) along the longitudinal axis X.

A second biasing member 40 (e.g., a second compression spring or trip spring) is disposed between the movable contact member 34 and the second end 16 of the housing 12. The second biasing member 40 acts on the movable contact member 34 in a second direction (arrow X2) along the longitudinal axis X that is opposite to the first direction (arrow X1).

When the temperature of the thermally responsive member 32 is lower than the threshold temperature, the thermally responsive member 32 has a solid physical state. The first biasing member 38 is biased between the thermally responsive member 32 and the movable contact member 34 and the second biasing member 40 is biased between the movable contact member 34 and the second end 16 of the housing 12. In this condition, the biasing force of the first biasing member 38 is greater than the biasing force of the second biasing member 40. As such, the movable contact member 34 is in direct contact with the distal end 30 of the second conductive member 26 and the inner surface 20 of the housing 12. The thermal fuse 10 is operable to allow current to flow through the thermal fuse 10, wherein the current path through the thermal fuse is from the first conductive member 24 to the inner surface 20 of the housing 12, then to the movable contact member 34, and then to the second conductive member 26.

When the temperature of the thermally responsive member 32 is at or higher than the threshold temperature, the thermally responsive member 32 changes its physical state from a solid physical state to a non-solid physical state. In this condition, the first biasing member 38 is relaxed such that the biasing force of the first biasing member 38 is less than the biasing force of the second biasing member 40. The second biasing member 40 then causes the movable contact member 34 to move away from the distal end 30 of the second conductive member 26. Whenthe components are separated, the peripheral portion 36 of the movable contact member 34 remains in contact with the inner surface 20 of the housing 12, but the electrical connection between the second conductive member 26 and the the movable contact member 34 is broken. In this condition, the thermal fuse 10 cannot be operated to conduct current through the thermal fuse 10.

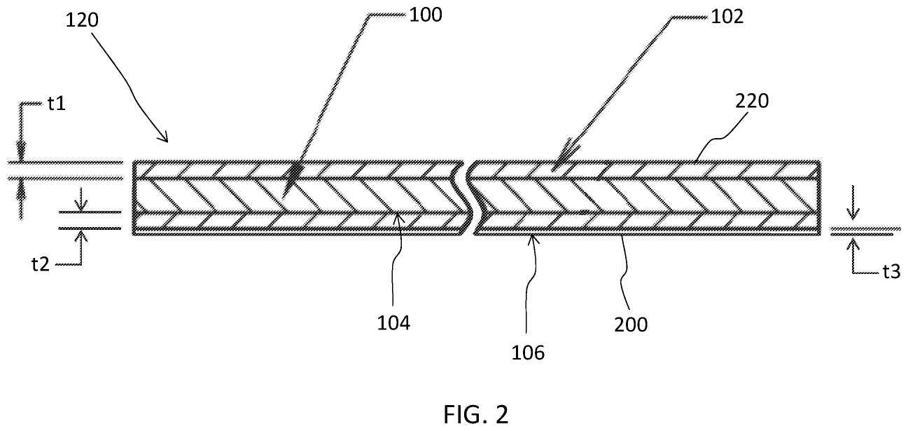

According to the principals of the present disclosure and as best seen in FIG. 2, a housing 120 for an improved thermal fuse is formed from a multilayer metal material that includes a copper-based layer 100; a first nickel layer 102, which is arranged on the first side of the copper-based layer 100 and includes the outer surface 220 of the housing 120; and a second nickel layer 104, which is arranged on the second side of the copper-based layer 100 opposite to the first side. A layer of silver 106 is arranged on the second nickel layer 104 and includes the inner surface 200 of the housing 120.

In this preferred embodiment, the housing 120 uses multiple layers of metal materials, including a copper-based layer 100, a first nickel layer 102, a second nickel layer 104, and a silver layer 106. The silver layer 106 is arranged on the second nickel layer 104 and includes the inner surface 200 of the housing 120, so that only the inner surface 200 of the housing 120 (and not the outer surface 220 of the housing 120) is silver-plated. The outer surface 220 is a nickel layer, so that the use of silver can be minimized while still maintaining the condition that the thermal fuse can complete the interruption performance.

Preferably, the thickness t1 of the first nickel layer ranges from 15 microinches to about 25 microinches, the thickness t2 of the second nickel layer ranges from 3 microinches to 5 microinches, and the thickness t3 of the silver layer ranges from 4 microinches to 100 microinches.

Preferably, as a preferred embodiment, the thickness t3 of the silver layer is less than 70 microinches.

Preferably, the thickness t3 of the silver layer is less than 30 microinches.

In some embodiments, the thickness t3 of the silver layer is less than 10 microinches.

In some preferred embodiments, the thickness t3 of the silver layer ranges from 4 microinches to about 6 microinches.

It should be noted that the foregoing embodiment is an example of the thickness of the silver layer, and those skilled in the art can select an appropriate thickness of the silver layer according to actual needs to ensure the cutting performance of the thermal fuse and optimize the reasonable amount of silver used.

Preferably, the roughness Ra of the outer surface 220 of the housing 120, Ra>35 microinches.

In this preferred embodiment, the roughness Ra of the outer surface 220 of the housing 120 is greater than 35 microinches. In this way, the roughness of the outer surface 220 of the thermal fuse can be increased, which helps to improve the quality of any printing or template applied or affixed to the outer surface 220 of the housing 120 (e.g., a part no.).

As a preferred embodiment, the copper-based layer 100 includes: copper, the content range is 84% to 86%, lead, the content range is less than or equal to 0.03%, iron, the content range is less than or equal to 0.05%, and cadmium, the content range is less than or equal to 0.007%, nickel, the content range is less than or equal to 0.01%, and the rest is zinc.

In the above embodiment, the copper-based layer 100 includes brass H85Cu.

Preferably, when the temperature of the thermally responsive member is at or higher than the threshold temperature and the movable contact member moves, the peripheral portion 36 of the movable contact member 34 remains in contact with the inner surface 200 of the housing 120, and any force resulting from friction between the peripheral portion 36 of the movable contact member 34 and the inner surface 200 of the housing 120 is less than about 0.3 kilogram-force (kgf).

In this preferred embodiment, a smaller frictional force can improve the interruption performance of the thermal fuse, making the use of the thermal fuse safer and more reliable.

Through experiments, when the thermal fuse is opened during the current interruption (CI) test, the higher the roughness of the outer surface 220 of the housing 120, the better the printing performance; the lower the roughness and friction of the inner surface of the housing 120, the better the current interruption performance.

It should be noted that those skilled in the art can design the roughness of the outer surface 220 of the housing 120 and the frictional coefficient of the inner surface 200 of the housing 120 according to actual needs.

Based on the same concept, this embodiment also provides a metal housing 120 for a thermal fuse, including: a first conductive member 24 disposed at the first end 14 of the housing 120 and extending from the housing 120 in the direction along the longitudinal axis X of the housing 120.

The second conductive member 26 is arranged at the second end 16 of the housing 120, extends from the housing 120 in a direction along the longitudinal axis X, and includes a contact surface 28 at the distal end 30, which is arranged in the inner space 18 of the housing 120.

The thermally responsive member 32 is located between the first and second conductive members 24, 26 and includes a non-conductive material. The non-conductive material changes from a solid physical state to a non-solid physical state when the temperature of the thermally responsive member 32 is at or above the threshold temperature.

The conductive movable contact member 34 is arranged inside the housing 120 and located between the thermally responsive member 32 and the distal end 30 of the second conductive member 26. The movable contact member 34 includes a peripheral portion 36 in contact with the inner surface 200 of the housing 120.

The first biasing member 38 is disposed between the thermally responsive member 32 and the movable contact member 34, and the first biasing member 38 acts on the movable contact member 34 in a first direction X1 along the longitudinal axis X.

The second biasing member 40 is disposed between the movable contact member 34 and the second end of the housing 120, and the second biasing member 40 acts on the movable contact member 34 in a second direction X2 along the longitudinal axis X that is opposite to the first direction X1.

When the temperature of the thermally responsive member 32 is lower than the threshold temperature, the physical state of the thermally responsive member is solid, the biasing force of the first biasing member 38 is greater than the biasing force of the second biasing member 40, the movable contact member 34 is in direct contact with the distal end 30 of the second conductive member 26, and the thermal fuse is operable to allow current to flow through the thermal fuse along the current path from the first conductive member 24 to the inner surface 200 of the housing 120, then to the movable contact member 34, and then to the second conductive member 26.

When the temperature of the thermally responsive member 32 is at or higher than the threshold temperature, the physical state of the thermally responsive member 32 is non-solid, the biasing force of the first biasing member 38 is less than the biasing force of the second biasing member 40, and the movable contact member 34 moves away from the distal end 30 of the second conductive member 26 and no longer contacts or conducts electricity with the second conductive member 26. The second conductive member 26 and movable contact member 34 components are separated, the peripheral portion 36 of the movable contact member 34 remains in contact with the inner surface 200 of the housing 120 and the thermal fuse cannot be operated to conduct current through the thermal fuse.

The housing 120 includes a multilayer metal material, the multilayer metal material includes: a copper-based layer 100; a first nickel layer 102, arranged on the first side of the copper-based layer 100 and including an outer surface 220; and a second nickel layer 104 arranged on the second side of the copper-based layer. 100 opposite to the first side. The silver layer 106 is arranged only on the second nickel layer 104 and includes the inner surface 200 of the housing 120.

In this preferred embodiment, the housing 120 uses multiple layers of metal materials, including a copper-based layer 100, a first nickel layer 102, a second nickel layer 104, and a silver layer 106. The silver layer 106 is arranged on the second nickel layer 104 and includes the inner surface 200 of the housing 120, so that only the inner surface 200 of the housing 120 is silver-plated, and the outer surface 220 is a nickel layer As such, the use of silver can be minimized provided that the thermal fuse can complete the interruption performance.

Preferably, the thickness t1 of the first nickel layer ranges from 15 microinches to about 25 microinches, the thickness t2 of the second nickel layer ranges from 3 microinches to 5 microinches, and the thickness t3 of the silver layer ranges from 4 microinches to 100 microinches.

Preferably, as a preferred embodiment, the thickness t3 of the silver layer is less than 70 microinches.

Preferably, the thickness t3 of the silver layer is less than 30 microinches.

In some embodiments, the thickness t3 of the silver layer is less than 10 microinches.

In some preferred embodiments, the thickness t3 of the silver layer ranges from 4 microinches to about 6 microinches.

It should be noted that the foregoing embodiment is an example of the thickness of the silver layer, and those skilled in the art can select an appropriate thickness of the silver layer according to actual needs to ensure proper performance of the thermal fuse while simultaneously reducing the amount of silver used in construction of the thermal fuse.

Preferably, the roughness Ra of the outer surface 220 of the housing 120 is Ra>35 microinches.

In this preferred embodiment, the outer surface 220 roughness of the housing 120 is Ra>35 microinches, and a surface roughness of the silver-plated layer 106 is minimal. The high roughness enables the outer service 220 to have good decorative performance and improve the quality of the template but not affect the performance of the thermal fuse which is improved by the minimal surface roughness of the inner surface 200.

As a preferred embodiment, the copper-based layer 100 includes: copper, the content range is 84% to 86%, lead, the content range is less than or equal to 0.03%, iron, the content range is less than or equal to 0.05%, and cadmium, the content range is less than or equal to 0.007%, nickel, the content range is less than or equal to 0.01%, and the rest is zinc.

In the above embodiment, the copper-based layer 100 includes brass H85Cu.

Preferably, when the thermally responsive member 32 is higher than the threshold temperature and the movable contact member 34 moves, the peripheral portion 36 of the movable contact member 34 remains in contact with the inner surface 200 of the housing 120, and any force resulting from friction between the peripheral portion 36 of the movable contact member 34 and the inner surface 200 of the housing 120 is less than about 0.3 kilogram-force (kgf).

In this preferred embodiment, a smaller frictional force can improve the interruption performance of the thermal fuse, making the use of the thermal fuse safer and more reliable.

Through experiments, when the thermal fuse is opened during the current interruption (CI) test, the higher the roughness of the outer surface 220 of the housing, the better the printing performance; the lower the roughness and friction of the inner surface 200 of the housing 120, the better the current interruption performance.

It should be noted that those skilled in the art can design the roughness of the outer surface of the housing and the frictional coefficient of the inner surface of the housing according to actual needs.

Through the above embodiments, a thermal fuse is provided.

Through this technical solution, the following technical effects are achieved: the surface roughness of the housing can be different between the silver-plated layer only on the inner surface and the nickel layer on the outer surface so the thermal fuse has a good balance of decorative performance and current interruption performance.

New circuits with capacitors and resistors may slow down the speed of the CI test. During the CI test, the DC voltage between the two ends of the thermal fuse according to the present disclosures increases and significantly improves the performance of the CI thermal fuse in DC applications.

The newly designed single-sided electroplated case can improve the current interruption performance of the thermal fuse.

It should be noted that these technical effects are not possessed by all the above-mentioned embodiments, and some technical effects can only be achieved by certain preferred embodiments.

The above are only preferred embodiments of the present invention, and are not used to limit the protection scope of the present invention.

Any modification, equivalent replacement, improvement, etc. made within the spirit and principle of the present invention are all included in the protection scope of the present invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A thermal fuse, characterized in that it comprises:
a housing, the housing extending from a first end to a second end along a longitudinal axis, the housing having an inner space, and the housing having an inner surface and an outer surface;
a first conductive member disposed at the first end of the housing and extending from the housing in a direction along the longitudinal axis;
a second conductive member disposed at the second end of the housing, and extending from the housing in the direction along the longitudinal axis, and including a contact surface provided at a distal end thereof;
a thermally responsive member disposed in the inner space of the housing and located between the first conductive member and the distal end of the second conductive member, the thermally responsive member including a non-conductive material, wherein the non-conductive material changes from a solid physical state to a non-solid physical state when a temperature of the thermally responsive member reaches a threshold temperature;
a conductive movable contact member disposed in the inner space of the housing and located between the thermally responsive member and the distal end of the second conductive member, the movable contact member including a peripheral portion in contact with the inner surface of the housing;
a first biasing member disposed between the thermally responsive member and the movable contact member, the first biasing member acting on the movable contact member with a first biasing force in a first direction along the longitudinal axis;
a second biasing member disposed between the movable contact member and the second end of the housing, the second biasing member acting on the moveable contact member with a second biasing force in a second direction along the longitudinal axis opposite to the first direction along the longitudinal axis;
wherein, when the temperature of the thermally responsive member is lower than the threshold temperature, the thermally responsive member is in a solid physical state, the first biasing force is greater than the second biasing force, the movable contact member is electrically connected to the second conductive member and the distal end of the second conductive member is in direct contact with the movable contact member, and the thermal fuse is operable to conductcurrent through the thermal fuse, wherein a current path through the thermal fuse is from the first conductive member to the inner surface of the housing, to the movable contact member, and to the second conductive member;
wherein, when the temperature of the thermally responsive member is at or higher than the threshold temperature, the thermally responsive member is in a non-solid physical state, the first biasing force is less than the second biasing force, the movable contact member is electrically disconnected from the second conductive member and the movable contact member is separated from the distal end of the second conductive member, the peripheral portion of the movable contact member remains in contact with the inner surface of the housing, and the thermal fuse is inoperable to conduct current through the thermal fuse;
wherein, the housing comprises a multilayer metal material construction comprising:
a copper-based layer having a first side and a second side that is opposite to the first side;
a first nickel layer disposed on the first side of the copper-based layer and comprising the outer surface of the housing;
a second nickel layerdisposed on the second side of the copper-based layer; and
a silver layer disposed on the second nickel layer and comprising the inner surface of the housing.

2. The thermal fuse of claim 1, wherein a thickness of the first nickel layer ranges from 15 microinches to about 25 microinches, a thickness of the second nickel layer ranges from 3 microinches to about 25 microinches, and a thickness of the silver layer ranges from 4 microinches to about 100 microinches.

3. The thermal fuse according to claim 2, wherein the thickness of the silver layer is less than 70 microinches.

4. The thermal fuse according to claim 2, wherein the thickness of the silver layer is less than 30 microinches.

5. The thermal fuse according to claim 2, wherein the thickness of the silver layer is less than 10 microinches.

6. The thermal fuse according to claim 2, wherein the thickness of the silver layer ranges from 4 microinches to about 6 microinches.

7. The thermal fuse according to claim 6, wherein the outer surface of the housing has a roughness Ra, Ra>35 microinches.

8. The thermal fuse according to claim 7, wherein the copper-based layer comprises: copper, with a content ranging from 84% to 86%, lead, with a content ranging less than or equal to 0.03%, iron, with a content of less than or equal to 0.05%, cadmium, with a content less than or equal to 0.007%, nickel, with a content less than or equal to 0.01%, and a remainder zinc.

9. The thermal fuse according to claim 8, wherein the copper-based layer comprises brass H85Cu.

10. The thermal fuse according to claim 9, wherein when the temperature of the thermally responsive member is at or higher than the threshold temperature and the movable contact member is separated from the distal end of the second conductive member, the peripheral portion of the movable contact member remains in contact with the inner surface of the housing, and a frictional force at the peripheral portion of the movable contact member and the inner surface of the housing and opposed to the second biasing force is less than about 0.3 kilogram-force (kgf).

11. A metal casing for a thermal fuse of a type comprising:
a first conductive member disposed at a first end of the metal casing and extending from the metal casing in a first direction along a longitudinal axis of the thermal fuse;
a second conductive member disposed at a second end of the metal casing, and extending from the metal casing in a second direction along the longitudinal axis, the second conductive member comprising a contact surface provided at a distal end thereof;
a thermally responsive member disposed in an internal space of the metal casing and located between the first conductive member and the distal end of the second conductive member and comprising a non-conductive material, wherein the non-conductive material changes from a solid physical state to a non-solid physical state at or above a threshold temperature ;
a conductive movable contact member provided in the internal space of the metal casing and located between the thermally responsive member and the distal end of the second conductive member, the movable contact member comprising a peripheral portion in contact with an inner surface of the metal casing;
a first biasing member disposed between the thermally responsive member and the movable contact member, the first biasing member acting on the movable contact with a first biasing force in a first direction along the longitudinal axis;
a second biasing member disposed between the movable contact member and the second end of the metal casing, the second biasing member acting on the movable contact with a second biasing force in a second direction along the longitudinal axis opposite to the first direction;
wherein, when a temperature of the thermally responsive member is lower than the threshold temperature, the first biasing force is greater than the second biasing force, and the movable contact member is electrically connected to the second conductive member and the distal end of the second conductive member is in direct contact with the movable contact member, the thermal fuse is operable to conduct current through the thermal fuse, wherein a current path through the thermal fuse is from the first conductive member to the inner surface of the metal casing, to the movable contact member, and to the second conductive member;
wherein, when the temperature of the thermally responsive member is greater than or equal to the threshold temperature, the first biasing force is less than the second biasing force, the movable contact member is electrically disconnected from the second conductive member and the movable contact member is separated from the distal end of the second conductive member, the peripheral portion of the movable contact member remains in contact with the inner surface of the metal casing, and the thermal fuse is inoperable to conduct current through the thermal fuse;
wherein the metal casing comprises a multilayer metal material, the multilayer metal material comprises: a copper-based layer; a first nickel layer disposed on a first side of the copper-based layer and including an outer surface of the metal casing; a second nickel layerdisposed on a second side of the copper-based layer opposite to the first side of the copper-based layer,; and a single silver layer disposed only on the second nickel layer and comprising the inner surface of the metal casing.

12. The metal casing of claim 11, wherein a thickness of the first nickel layer ranges from 15 microinches to about 25 microinches, a thickness of the second nickel layer ranges from 3 microinches to about 25 microinches, and a thickness of the silver layer ranges from 4 microinches to 100 microinches.

13. The metal casing of claim 12, wherein the thickness of the silver layer is less than 70 microinches.

14. The metal casing of claim 12, wherein the thickness of the silver layer is less than 30 microinches.

15. The metal casing of claim 12, wherein the thickness of the silver layer is less than 10 microinches.

16. The metal casing of claim 12, wherein the thickness of the silver layer ranges from 4 microinches to about 6 microinches.

17. The metal casing for a thermal fuse according to claims 16, wherein the outer surface of the metal casing has a roughness Ra, Ra>35 microinches.

18. The metal casing of claim 17, wherein the copper-based layer comprises:
copper, with a content ranging from 84% to 86%;
lead, with a content ranging less than or equal to 0.03%;
iron, with a content less than or equal to 0.05%;
cadmium, with a content less than or equal to 0.007% nickel, with a the content less than or equal to 0.01%;, and a remainder zinc.

19. The metal casing of claim 18, wherein the copper-based layer comprises brass H85Cu.
